(19) United States
(12) Patent Application Publication
(10) Pub. No.: US 2010/0129653 A1
(43) Pub. Date: May 27, 2010

(54) PRESSURE-SENSITIVE ADHESIVE TAPE

(75) Inventors: Masato Koike, Susono-shi (JP); Susumu Hara, Susono-shi (JP); Hiroshi Ichikawa, Susono-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 11/720,799

(22) PCT Filed: Dec. 9, 2005
(86) PCT No.: PCT/JP05/22680

§ 371 Date: Jun. 4, 2007

(30) Foreign Application Priority Data
Dec. 10, 2004 (JP) 2004-358747

(51) Int. Cl. B32B 7/10

(52) U.S. Cl. 428/355 AC

(57) ABSTRACT

Disclosed is a halogen-free adhesive tape whose binding force is improved by increasing adhesion at low temperatures. Specifically disclosed is a halogen-free adhesive tape which is characterized in that an adhesive containing a natural rubber, an acrylic resin, an adhesiveness-imparting resin, an antioxidant and a plasticizer having a molecular weight of 450-3000 and a freezing point of from −30° C. to −55° C. is applied over at least one side of a tape base which is composed of a non-halogen resin composition containing no halogen element.

### TECHNICAL FIELD

The present invention relates to a halogen-free pressure-sensitive adhesive tape obtained by applying a pressure-sensitive adhesive to a tape substrate made of a non-halogen resin composition containing no halogen elements.

### BACKGROUND ART

With the recent trend toward performance elevation and function advancement in motor vehicles, electrified products, etc., such products have come to be provided with many electric wires and wire harnesses are frequently used in wiring. These wire harnesses are systems produced by processing electric wires beforehand so as to have necessary forms, specifically, subjecting wires to branching, connector attachment to ends, etc., and binding the processed electric wires by winding a pressure-sensitive adhesive tape therearound.

The pressure-sensitive adhesive tapes heretofore in general use are PVC-based pressure-sensitive adhesive tapes obtained by applying a pressure-sensitive adhesive to a substrate made of a vinyl chloride resin composition. However, there is a problem that these pressure-sensitive adhesive tapes generate a halogen gas or halogen compound gas upon incineration disposal, etc. to cause environmental pollution. The conventional pressure-sensitive adhesive tapes are hence being replaced by halogen-free pressure-sensitive adhesive tapes employing as the substrate a non-halogen resin composition containing no halogen elements (see, for example, patent document 1 and patent document 2).

[Patent Document 1] JP-A-2003-178628

[Patent Document 2] JP-A-2003-219533

### DISCLOSURE OF THE INVENTION

### Problem that the Invention is to Solve

Incidentally, in PVC-based pressure-sensitive adhesive tapes, flexibility is imparted to the substrate by adding a plasticizer because the substrate comprises a rigid vinyl chloride resin. This plasticizer migrates to the pressure-sensitive adhesive side and, hence, the pressure-sensitive adhesive also has some degree of flexibility and is less apt to decrease in adhesion. Because of this, even at low temperatures not higher than 0° C., binding operations can be conducted without particularly arousing a trouble.

On the other hand, in the case of halogen-free pressure-sensitive adhesive tapes, no plasticizer is added because the substrate is made of a flexible polyolefin resin. Consequently, plasticizer migration from the substrate to the pressure-sensitive adhesive does not occur, and this arouses a trouble that in binding operations especially at low temperatures, the tape gets loose or suffers wrinkling, etc. due to a deficiency in adhesion to impair the finish or appearance of the wire harness.

The invention has been achieved under these circumstances. An object of the invention is to heighten the low-temperature adhesion of a halogen-free pressure-sensitive adhesive tape to improve suitability for binding.

### Means for Solving the Problem

In order to overcome the problem described above, the invention provides the following halogen-free pressure-sensitive adhesive tapes.

(1) A halogen-free pressure-sensitive adhesive tape which comprises a tape substrate made of a non-halogen resin composition containing no halogen elements and, applied to at least one side of the substrate, a pressure-sensitive adhesive which comprises natural rubber, an acrylic resin, a tackifier resin, an antioxidant, and a plasticizer having a molecular weight of 450-3,000 and a solidifying point of from −30° C. to −55° C.

(2) The halogen-free pressure-sensitive adhesive tape according to the above (1), wherein the plasticizer is an ester plasticizer or a trimellitic acid compound plasticizer.

(3) The halogen-free pressure-sensitive adhesive tape according to the above (1) or (2), wherein the content of the plasticizer is 8-12 parts by weight per 100 parts by weight of the sum of the natural rubber, the acrylic resin, the tackifier resin, and the antioxidant.

(4) The halogen-free pressure-sensitive adhesive tape according to any one of the above (1) to (3), which is for use in wire harness binding.

### ADVANTAGE OF THE INVENTION

The halogen-free pressure-sensitive adhesive tape of the invention is less apt to decrease in adhesion at low temperatures and has excellent binding performance because it employs the pressure-sensitive adhesive containing a specific plasticizer. Consequently, by using the halogen-free pressure-sensitive adhesive tape of the invention, a wire harness having an excellent finish or appearance is obtained.

### BEST MODE FOR CARRYING OUT THE INVENTION

The invention will be explained below in detail.

The substrate of the halogen-free pressure-sensitive adhesive tape of the invention is made of an olefin resin composition. Preferred examples thereof include a non-halogen flame-retardant olefin resin obtained by adding a flame retardant comprising a metal hydroxide such as magnesium hydroxide or aluminum hydroxide, an antioxidant such as a phenol compound or an amine compound, a copper inhibitor such as a triazine derivative, etc. into a base resin comprising polypropylene, polyethylene, a propylene/ethylene copolymer, or the like. However, the resin composition should not be construed as being limited to the example. The thickness of the substrate may be the same as in general pressure-sensitive adhesive tapes, and is generally 5-500 μm.

A pressure-sensitive adhesive is applied to the substrate. The pressure-sensitive adhesive comprises natural rubber, an acrylic resin, a tackifier resin, and an antioxidant as major ingredients and further contains a plasticizer having a molecular weight of 450-3,000 and a solidifying point of from −30° C. to −55° C. Plasticizers having a molecular weight lower than 450 are apt to migrate to electric-wire coating materials and to thereby deteriorate the electric-wire coating materials. On the other hand, plasticizers having a molecular weight exceeding 3,000 are poor in the effect of softening the pressure-sensitive adhesive at low temperatures and thereby reduce suitability for binding.

In case where a plasticizer having a solidifying point lower than −55° C. is used, the pressure-sensitive adhesive has low adhesion especially at low temperatures and the tape is apt to get loose and wrinkle in tape winding operations to impair the appearance of the wire harness. On the other hand, in case where a plasticizer having a solidifying point higher than −30° C. is used, the pressure-sensitive adhesive has too high adhesion especially at low temperatures and the tape is apt to zip upon stripping. In this case also, the wire harness is apt to have an impaired appearance.

The content of the plasticizer in the pressure-sensitive adhesive preferably is 8-12 parts by weight per 100 parts by weight of the sum of the natural rubber, acrylic resin, tackifier resin, and antioxidant (i.e., the major ingredients). The pressure-sensitive adhesive in the halogen-free pressure-sensitive adhesive tape of the invention contains a plasticizer unlike those in PVC-based pressure-sensitive adhesive tapes and, hence, the pressure-sensitive adhesive tape of the invention is apt to cause plasticizer migration to electric-wire coating materials. Because of this, the plasticizer content is regulated so that the upper limit thereof is 12 parts by weight to thereby prevent excessive migration to electric-wire coating materials.

In addition, in case where the content of the plasticizer exceeds 12 parts by weight, the softening effect becomes too high and the pressure-sensitive adhesive suffers a cohesive failure upon tape stripping to leave a pressure-sensitive adhesive residue on the electric-wire surface. However, in case where the content of the plasticizer is lower than 8 parts by weight, the softening effect is insufficient and the pressure-sensitive adhesive tape has poor suitability for binding especially at low temperatures and causes an appearance failure due to zipping.

The composition and kind of the plasticizer are not limited as long as the plasticizer has the specific molecular weight and solidifying point shown above. However, polyester, trimellitic acid compound, and phthalic acid compound plasticizers are preferred.

Specifically, examples of the polyester plasticizers include an adipic acid polyester (molecular weight, 800; solidifying point, −45° C.) and a polyester glutarate (molecular weight, 2,500; solidifying point, −40° C.), and examples of the trimellitic acid compound plasticizers include triisodecyl trimellitate (molecular weight, 630; solidifying point, −40° C.) and triisooctyl trimellitate (molecular weight, 550; solidifying point, −45° C.). Such plasticizers are available also on the market. For examples, plasticizer emulsion “KE-799 (molecular weight, 550; solidifying point, −50° C.)”, manufactured by Arakawa Chemical Ltd., can be used.

The major ingredients are explained next. Examples of the acrylic resin include homopolymers of a main monomer such as acrylic acid or an acrylic ester, e.g., ethyl acrylate, butyl acrylate, or 2-ethylhexyl acrylate, and copolymers of the main monomer and one or more monomers such as vinyl acetate and methyl methacrylate.

Examples of the tackifier resin include rosin resins such as rosin, rosin gum, tail oil rosin, hydrogenated rosin, and maleic-modified rosin, terpene-phenol resins, terpene resins consisting mainly of α-pinene, β-pinene, limonene, etc., aromatic-hydrocarbon-modified terpene resins, aliphatic, alicyclic, and aromatic petroleum resins, coumarone-indene resins, styrene resins, phenolic resins such as alkylphenol resins and rosin-modified phenolic resins, and xylene resins. These may be used alone or in suitable combination of two or more thereof.

Examples of the antioxidant include phenol compounds (hindered phenols) such as 2,6-di-t-butyl-p-cresol (BHT), 2,2′-methylenebis(4-methyl-6-t-butylphenol), triethylene glycol bis[3-(3-t-butyl-5-methyl-4-hydroxyphenyl)propionate] and pentaerythrityl tetrakis[3-(3,5-di-t-butyl-4-hydroxyphenyl)propionate], sulfur compounds such as dilauryl 3,3-thiodipropionate (DLTDP) and distearyl 3,3′-thiodipropionate (DSTDP), phosphorus compounds such as triphenyl phosphite (TPP), triisodecyl phosphite (TDP), tri(2,4-di-t-butylphenyl) phosphite, and 2,2-methylenebis(4,6-di-t-butylphenyl) octyl phosphite, and amine compounds (hindered aromatic amines) such as octyldiphenylamine, N-n-butyl-p-aminophenol, and N,N-diisopropyl-p-phenylenediamine. These may be used alone or in suitable combination of two or more thereof.

The proportions of the natural rubber, acrylic resin, tackifier resin, and antioxidant to be incorporated are not limited, and are suitably determined according to the desired pressure-sensitive adhesive performance.

Various additives which have been added to pressure-sensitive adhesives can be incorporated into the pressure-sensitive adhesive. For example, a thickener may be incorporated. Examples thereof include carboxyvinyl polymers, carboxymethyl cellulose, gelatin, dextrin, hydroxypropylmethyl cellulose, hydroxypropyl cellulose, and alginic acid (salts). These may be used alone or in suitable combination of two or more thereof.

A softener can be incorporated. Examples thereof include styrene resins and petroleum-derived softeners. These may be used alone or in suitable combination of two or more thereof.

A filler can be incorporated. Examples thereof include magnesium carbonate, calcium carbonate, aluminum sulfate, calcium sulfate, barium sulfate, calcium sulfite, molybdenum disulfide, aluminum silicate, calcium silicate, diatomaceous earth, silica rock powder, talc, silica, and zeolite. These may be used alone or in suitable combination of two or more thereof.

A pigment can be incorporated. Examples thereof include inorganic pigments such as alumina white, graphite, titanium oxide, zinc white, black iron oxide, micaceous iron oxide, white lead, white carbon, molybdenum white, carbon black, litharge, lithopone, barite, cadmium red, cadmium-mercury red, red iron oxide, molybdenum red, red lead, yellow lead, cadmium yellow, barium yellow, strontium yellow, titanium yellow, titanium black, chromium oxide green, cobalt oxide, cobalt green, cobalt-chromium green, ultramarine, prussian blue, cobalt blue, cerulean blue, manganese violet, and cobalt violet and organic pigments such as shellac, insoluble azo pigments, soluble azo pigments, condensation azo pigments, phthalocyanine blue, and color lakes. These may be used alone or in suitable combination of two or more thereof.

An ultraviolet absorber can be incorporated. Examples thereof include salicyclic acid derivatives such as phenyl salicylate, p-octylphenyl salicylate, and p-t-butylphenyl salicylate, benzophenone compounds such as 2,4-dihydroxybenzophenone, 2-hydroxy-4-methoxybenzophenone, 2,2′-dihydroxy-4-methoxybenzophenone, 2,2′-dihydroxy-4,4′-dimethoxybenzophenone, 2,2′-dihydroxy-4,4′-dimethoxy-5-sulfobenzophenone, 2-hydroxy-4-methoxy-2′-carboxybenzophenone, 2-hydroxy-4-methoxy-5-sulfobenzophenone trihydrate, 2-hydroxy-4-n-octoxybenzophenone, 2-hydroxy-4-octadecyloxybenzophenone, 2,2′,4,4′-tetrahydroxybenzophenone, 4-dodecyloxy-2-hydroxybenzophenone, 2-hydroxy-4-(2-hydroxy-3-methacryloxy)propoxybenzophenone, and bis(2-methoxy-4-hydroxy-5-benzoylphenyl)methane, benzotriazole compounds such as 2-(2′-hydroxy-5′-methylphenyl)benzotriazole, 2-(2′-hydroxy-3′,5′-di-tert-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-4′-n-octoxyphenyl)benzotriazole, 2-(2′-hydroxy-5′-n-t-butylphenyl)benzotriazole, 2-(2′-hydroxy-3′,5′-di-t-amylphenyl)benzotriazole, 2-[2′-hydroxy-3′-(3″,4″,5″,6″-tetrahydrophthalimidomethyl)-5′-methylphenyl]benzotriazole, and 2,2-methylenebis[4-(1,1,3,3-tetramethylbutyl)-6-(2H-benzotriazol-2-yl)phenol], and cyanoacrylate compounds such as 2-ethylhexyl 2-cyano-3,3′-diphenylacrylate and ethyl 2-cyano-3,3′-diphenylacrylate. These may be used alone or in suitable combination of two or more thereof.

Besides the ingredients shown above, various additives for pressure-sensitive adhesives, such as an antibacterial, lubricant, anti-blocking agent, and antistatic agent, can be incorporated according to need. These may be used alone or in suitable combination.

For preparing the pressure-sensitive adhesive, the major ingredients, plasticizer, and additives described above may be mixed according to a given formulation in the same manner as for pressure-sensitive adhesives heretofore in use. For example, a roll mill, Banbury mixer, Brabender, kneader, or the like may be used for the mixing. The major ingredients, plasticizer, and additives may be in any of an emulsion form, solvent-based form, and the like.

In applying the pressure-sensitive adhesive to the substrate in the case where the adhesive is in a solvent-based form, the ingredients are dissolved in an appropriate solvent and this coating fluid is applied. Examples of the solvent include esters such as methyl formate, ethyl acetate, and butyl acetate, alcohols such as isopropanol, hydrocarbons such as hexane, cyclohexane, toluene, and xylene, and ketones such as acetone, methyl ethyl ketone, and cyclohexanone. The amount of the solvent to be used is 5-900% by weight, preferably 10-400% by weight, based on the total weight of the pressure-sensitive adhesive from the standpoint of applicability. The viscosity of the coating fluid is 1,000-50,000 mPa·s (25° C.), preferably 2,000-30,000 mPa·s (25° C.), from the standpoint of applicability.

The amount of the pressure-sensitive adhesive to be applied may be the same as in general pressure-sensitive adhesive tapes. An appropriate range thereof is 10-150 μm in terms of thickness on a dry basis. Incidentally, priming the substrate can enhance adhesion between the substrate and the pressure-sensitive adhesive.

### EXAMPLES

The invention will be further explained below by reference to Test Examples, but the invention should not be construed as being limited by these Examples in any way.

### (Test 1)

Pressure-Sensitive Adhesives Prepared According to the formulations shown in Table 1 were used to produce pressure-sensitive adhesive tapes A to G. Pressure-sensitive adhesive tapes A to E were produced by applying the pressure-sensitive adhesives shown in the table to a halogen-free tape substrate made of an ethylene/propylene copolymer containing magnesium hydroxide as a flame retardant. Pressure-sensitive adhesive tape F was produced by applying the pressure-sensitive adhesive shown in the table to a commercial substrate for PVC pressure-sensitive adhesive tapes. Pressure-sensitive adhesive tape G was produced by applying a commercial pressure-sensitive adhesive (its composition is as shown in the table) for PVC pressure-sensitive adhesive tapes to the same halogen-free tape substrate. These pressure-sensitive adhesive tapes were subjected to the following evaluations. The results thereof are shown in Table 1.

### (1) Adhesion at Low Temperature

After a pressure-sensitive adhesive tape was allowed to stand in a 0° C. thermostatic chamber for 3 hours, it was examined for adhesion in accordance with JIS 02107 (Back Adhesion Test Method). The cases which were superior, equal, and inferior in adhesion to a commercial PVC pressure-sensitive adhesive tape are indicated by “A”, “B”, and “C”, respectively. The case where the pressure-sensitive adhesive tape had no tackiness and was considerably inferior in adhesion is indicated by “D”.

### (2) Suitability for Low-Temperature Winding Operation (Unsusceptibility to Getting Loose)

A winding operation was conducted in a 0° C. atmosphere. The case where the pressure-sensitive adhesive tape did not get loose in this operation is indicated by “A” and the case where the pressure-sensitive adhesive tape got loose is indicated by “B”.

### (3) Suitability for Low-Temperature Winding Operation (Zipping)

After a pressure-sensitive adhesive tape was allowed to stand in a 0° C. thermostatic chamber for 3 hours, it was peeled off at 10 m/min. The case where the tape did not zip upon the peeling is indicated by “A” and the case where the tape zipped is indicated by “B”.

### (4) Evaluation of Wire Harness Appearance

Six electric wires were bound by winding a pressure-sensitive adhesive tape therearound so as to make 5 laps, and the bound electric wires were evaluated for appearance. The case where the pressure-sensitive adhesive tape was free from wrinkling, end peeling, and adhesion of dust particles, etc. like the commercial PVC pressure-sensitive adhesive tape is indicated by “A”. The case where the pressure-sensitive adhesive tape developed a larger number of wrinkles as compared with the commercial PVC pressure-sensitive adhesive tape and suffered end peeling and considerable adhesion of dust particles, etc. is indicated by “B”.

TABLE 1

| | Pressure- | Pressure- | Pressure- | Pressure- | Pressure- | Pressure- | Pressure- |
|---|---|---|---|---|---|---|---|
| | sensitive | sensitive | sensitive | sensitive | sensitive | sensitive | sensitive |
| | adhesive | adhesive | adhesive | adhesive | adhesive | adhesive | adhesive |
| | tape A | tape B | tape C | tape D | tape E | tape F | tape G |
| Natural rubber | 10 | 10 | 10 | 10 | 10 | 10 | 30 |
| Acrylic resin A | 70 | 70 | 70 | 70 | 70 | 70 | |
| Acrylic resin B | | | | | | | 40 |
| Tackifier resin | 18 | 18 | 18 | 18 | 18 | 18 | 28 |
| Antioxidant A | 2 | 2 | 2 | 2 | 2 | 2 | |
| Antioxidant B | | | | | | | 2 |
| Softener | plasticizer A | plasticizer B | plasticizer E | plasticizer G | plasticizer H | plasticizer C | |
| | | plasticizer C | plasticizer F | | plasticizer I | plasticizer D | |
| | | plasticizer D | | | | | |
| Low-temperature | C | B | B | A | A | C | D |
| adhesion | | | | | | | |
| Unsusceptibility | B | A | A | A | A | B | B |
| to getting loose | | | | | | | |
| Zipping | A | A | A | B | B | A | A |
| Appearance | B | A | A | B | B | B | B |

Ingredient amount: parts by weight

### Note)

Acrylic resin A: “SC-2” manufactured by Musashino Chemical Ltd.

Acrylic resin B: “TS-805” manufactured by Nippon Carbide Co., Ltd.

Tackifier resin: “E-726” manufactured by Arakawa Chemical Ltd.

Antioxidant A: “EK-800” manufactured by Arakawa Chemical Ltd.

Antioxidant B: “KM 2106” manufactured by API Corporation

Plasticizer A: octyl adipate plasticizer (solidifying point, −60° C.)

Plasticizer B: phthalic acid compound plasticizer (solidifying point, −53° C.; molecular weight, 391)

Plasticizer C: trimellitic acid compound plasticizer (solidifying point, −45° C.; molecular weight, 630)

Plasticizer D: polyester plasticizer (solidifying point, −50° C.; molecular weight, 2,000)

Plasticizer E: polyester plasticizer (solidifying point, −40° C.; molecular weight, 2,500)

Plasticizer F: trimellitic acid compound plasticizer (solidifying point, −30° C.; molecular weight, 550)

Plasticizer G: polyester plasticizer (solidifying point, −25° C.; molecular weight, 4,200)

Plasticizer H: polyester plasticizer (solidifying point, −5° C.; molecular weight, 4,500)

Plasticizer I: epoxy plasticizer (solidifying point, −15° C.; molecular weight, 1,000)

Table 1 shows the following. Pressure-sensitive adhesive tape B and pressure-sensitive adhesive tape C, which were obtained according to the invention by applying a pressure-sensitive adhesive containing plasticizers each having a solidifying point of from −30° C. to −55° C. to a halogen-free tape substrate, are satisfactory in all evaluations. In contrast, pressure-sensitive adhesive tape A, which was obtained by applying a pressure-sensitive adhesive containing a plasticizer having a solidifying point of −60° C., has low low-temperature adhesion, is apt to get loose, and is inferior in finish. Pressure-sensitive adhesive tape D and pressure-sensitive adhesive tape E, which were obtained by applying one or two plasticizers each having a solidifying point higher than −30° C., are apt to zip at the low temperature and are inferior in finish. Pressure-sensitive adhesive tape F, which employs a substrate for PVC pressure-sensitive adhesive tapes although the pressure-sensitive adhesive used contains a plasticizer having a solidifying point of −50° C., has low low-temperature adhesion, is apt to get loose, and is inferior also in finish. Furthermore, pressure-sensitive adhesive tape G, which employs a combination of a pressure-sensitive adhesive for PVC pressure-sensitive adhesive tapes and a halogen-free tape substrate, has especially low low-temperature adhesion, is apt to get loose, and is inferior also in finish.

### (Test 2)

Pressure-sensitive adhesives containing plasticizers differing in molecular weight as shown in Table 2 were applied to a halogen-free tape substrate to produce pressure-sensitive adhesive tapes H to L. These pressure-sensitive adhesive tapes were subjected to the following evaluations. The results thereof are shown in Table 2.

### (5) Deterioration of Electric-Wire Coating Material

Six electric wires having an appropriate length cut cut of a halogen-free electric wire obtained by coating a copper wire with an olefin resin were bound by winding a pressure-sensitive adhesive tape therearound so as to make 5 laps. Thus, a sample was produced. After this sample was heated at 140° C., the pressure-sensitive adhesive tape was stripped off to separate the sample into the individual electric wires. The electric wires which had been in contact with the pressure-sensitive adhesive side of the pressure-sensitive adhesive tape were wound one by one around a mandrel having the same outer diameter as the electric wires. Each electric wire wound was visually examined for cracks in the coating material. The series of operations consisting of binding with the pressure-sensitive adhesive tape, heating, tape stripping, and winding around a mandrel was repeatedly conducted at a given time interval to measure the time required for the coating material to develop cracks. Furthermore, a test was conducted in which electric wires were not bound with a pressure-sensitive adhesive tape and were subjected only to winding around a mandrel; this case was used as a reference (“A” in the table). The cases which were equal, slightly inferior, and considerably inferior to the reference are indicated by “B”, “C”, and “D”, respectively.

### (6) Suitability for Winding Operation

After a pressure-sensitive adhesive tape was allowed to stand in a 24° C. thermostatic chamber for 3 hours, it was peeled off at 10 m/min. The case where the tape did not zip upon the peeling is indicated by “A” and the case where the tape zipped is indicated by “B”.

TABLE 2

| | Pressure- | Pressure- | Pressure- | Pressure- | Pressure- | |
|---|---|---|---|---|---|---|
| | sensitive | sensitive | sensitive | sensitive | sensitive | |
| | adhesive | adhesive | adhesive | adhesive | adhesive | |
| | tape H | tape I | tape J | tape K | tape L | Reference |
| Natural rubber | 10 | 10 | 10 | 10 | 10 | |
| Acrylic resin | 70 | 70 | 70 | 70 | 70 | |
| Tackifier resin | 18 | 18 | 18 | 18 | 18 | |
| Antioxidant | 2 | 2 | 2 | 2 | 2 | |
| Softener | plasticizer J | plasticizer K | plasticizer M | plasticizer P | plasticizer Q | |
| | | plasticizer L | plasticizer N | | | |
| | | | plasticizer O | | | |
| Deterioration of | D | C | B | B | B | A |
| coating material | | | | | | |
| Zipping | A | A | A | A | B | — |

Ingredient amount: parts by weight

### Note)

Acrylic resin: “SC-2” manufactured by Musashino Chemical Ltd.

Tackifier resin: “E-726” manufactured by Arakawa Chemical Ltd.

Antioxidant: “EK-800” manufactured by Arakawa Chemical Ltd.

Plasticizer J: glyceryl acetate plasticizer (solidifying point, −35° C.; molecular weight, 200 or lower)

Plasticizer K: octyl adipate plasticizer (solidifying point, −60° C.; molecular weight, 373)

Plasticizer L: phthalic acid compound plasticizer (solidifying point, −53° C.; molecular weight, 390)

Plasticizer M: polyester plasticizer (solidifying point, −20° C.; molecular weight, 1,000)

Plasticizer N: trimellitic acid compound plasticizer (solidifying point, −30° C.; molecular weight, 550)

Plasticizer O: epoxy plasticizer (solidifying point, −12° C.; molecular weight, 450)

Plasticizer P: polyester plasticizer (solidifying point, −10° C.; molecular weight, 1,100)

Plasticizer Q: polyester plasticizer (solidifying point, −20° C.; molecular weight, 4,000)

Table 2 shows the following. Pressure-sensitive adhesive tape J and pressure-sensitive adhesive tape K, which were obtained according to the invention by applying a pressure-sensitive adhesive containing one or more plasticizers each having a molecular weight of 450-300, do not cause the electric-wire coating material to deteriorate. These pressure-sensitive adhesive tapes further have satisfactory suitability for binding. In contrast, pressure-sensitive adhesive tape H and pressure-sensitive adhesive tape I, which were obtained by applying a pressure-sensitive adhesive containing one or two plasticizers each having a molecular weight lower than 450, are apt to undergo plasticizer migration to the electric-wire coating material, leading to coating material deterioration. Furthermore, pressure-sensitive adhesive tape L, which was obtained by applying a pressure-sensitive adhesive containing a plasticizer having a molecular weight exceeding 3,000, has poor suitability for binding.

It can be seen from Test 1 and Test 2 that it is effective to use one or more plasticizers each having a solidifying point of from −30° C. to −55° C. and a molecular weight of 450-3,000.

### (Test 3)

Pressure-sensitive adhesives prepared according to the formulations shown in Table 3 were used to produce pressure-sensitive adhesive tapes M to S. Pressure-sensitive adhesive tapes M to Q were produced by applying the pressure-sensitive adhesives shown in the table to a halogen-free tape substrate. Pressure-sensitive adhesive tape R was produced by applying the pressure-sensitive adhesive shown in the table to a commercial substrate for PVC pressure-sensitive adhesive tapes. Pressure-sensitive adhesive tape S was produced by applying a commercial pressure-sensitive adhesive (its composition is as shown in the table) for PVC pressure-sensitive adhesive tapes to the halogen-free tape substrate. These pressure-sensitive adhesive tapes were subjected to the following evaluations. The results thereof are shown in Table 3.

### (7) Adhesion

A pressure-sensitive adhesive tape was examined for adhesion in accordance with JIS 02107 (Back Adhesion Test Method). The cases which were superior, equal, and inferior in adhesion to a commercial PVC pressure-sensitive adhesive tape are indicated by “A”, “B”, and “D”, respectively. The case where the pressure-sensitive adhesive tape had no tackiness and was considerably inferior in adhesion is indicated by “E”.

### (8) Suitability for Winding Operation (Unsusceptibility to Getting Loose)

A winding operation was conducted at room temperature. The case where the pressure-sensitive adhesive tape did not get loose in this operation is indicated by “A” and the case where the pressure-sensitive adhesive tape got loose is indicated by “B”.

### (9) Suitability for Winding Operation (Zipping)

After a pressure-sensitive adhesive tape was allowed to stand in a 24° C. thermostatic chamber for 3 hours, it was peeled off at 10 m/min. The case where the tape did not zip upon the peeling is indicated by “A” and the case where the tape zipped is indicated by “B”.

### (10) Adhesive Transfer

A pressure-sensitive adhesive tape was peeled off and the back side of this tape was examined for an adhesive residue thereon. The case where the back side had no adhesive residue is indicated by “A” and the case where the back side had an adhesive residue is indicated by “B”.

### (11) End Peeling

Six electric wires were bound by winding a pressure-sensitive adhesive tape therearound so as to make 5 laps. The bound electric wires were allowed to stand in an 80° C. thermostatic chamber for 24 hours and then taken out of the thermostatic chamber. The case where the pressure-sensitive adhesive tape suffered no end peeling is indicated by “A” and the case where the pressure-sensitive adhesive tape suffered end peeling is indicated by “B”.

### (12) Evaluation of Wire Harness Appearance

Six electric wires were bound by winding a pressure-sensitive adhesive tape therearound so as to make laps, and the bound electric wares were evaluated for appearance. The case where the pressure-sensitive adhesive tape was free from wrinkling, end peeling, and adhesion of dust particles, etc. like the commercial PVC pressure-sensitive adhesive tape is indicated by “A”. The case where the pressure-sensitive adhesive tape developed a larger number of wrinkles as compared with the commercial PVC pressure-sensitive adhesive tape and suffered end peeling and considerable adhesion of dust particles, etc. is indicated by “B”.

TABLE 3

| | Pressure- | Pressure- | Pressure- | Pressure- | Pressure- | Pressure- | Pressure- |
|---|---|---|---|---|---|---|---|
| | sensitive | sensitive | sensitive | sensitive | sensitive | sensitive | sensitive |
| | adhesive | adhesive | adhesive | adhesive | adhesive | adhesive | adhesive |
| | tape M | tape N | tape O | tape P | tape Q | tape R | tape S |
| Natural rubber | 10 | 10 | 10 | 10 | 10 | 10 | 30 |
| Acrylic resin A | 70 | 70 | 70 | 70 | 70 | 70 | |
| Acrylic resin B | | | | | | | 40 |
| Tackifier resin | 18 | 18 | 18 | 18 | 18 | 18 | 28 |
| Antioxidant A | 2 | 2 | 2 | 2 | 2 | 2 | |
| Antioxidant B | | | | | | | 2 |
| Plasticizer | ≦4 | 5-7 | 8-12 | 13-15 | ≧16 | 10 | — |
| Adhesion | A | A | B | C | D | D | E |
| Unsusceptibility | A | A | A | B | B | B | B |
| to getting loose | | | | | | | |
| Zipping | B | B | A | A | A | A | A |
| Adhesive remaining | A | A | A | B | B | B | A |
| End peeling | A | A | A | B | B | B | B |
| Appearance | B | B | A | B | B | B | B |

Ingredient amount: parts by weight

### Note)

Acrylic resin A: “SC-2” manufactured by Musashino Chemical Ltd.

Acrylic resin B: “TS-805” manufactured by Nippon Carbide Co., Ltd.

Tackifier resin: “E-726” manufactured by Arakawa Chemical Ltd.

Antioxidant A: “KE-800” manufactured by Arakawa Chemical Ltd.

Antioxidant B: “RE 21-6” manufactured by API Corporation

Plasticizer: “KE-799” manufactured by Arakawa Chemical Ltd. (solidifying point, −50° C.; molecular weight, 550)

It can be seen from Table 3 that the content of the plasticizer is preferably 8-12 parts by weight per 100 parts by weight of the major ingredients. The pressure-sensitive adhesive tapes in which the plasticizer content is lower than 8 parts by weight are apt to zip and give an impaired finish. The pressure-sensitive adhesive tapes in which the plasticizer content exceeds 12 parts by weight get loose and suffer adhesive remaining and end peeling in addition to the tendency to zip and give an impaired finish. Furthermore, pressure-sensitive adhesive tape R, which employs a substrate for PVC pressure-sensitive adhesive tapes although the plasticizer content is within the range specified in the invention, and pressure-sensitive adhesive tape G, which employs a combination of a pressure-sensitive adhesive for PVC pressure-sensitive adhesive tapes and a halogen-free tape substrate, further suffer a decrease in adhesion.

While the invention has been described in detail and with reference to specific embodiments thereof, it will be apparent to ones skilled in the art that various changes and modifications can be made therein without departing from the spirit and scope thereof.

This application is based on a Japanese patent application filed on Dec. 10, 2004 (Application No. 2004-358747), the entire contents thereof being herein incorporated by reference.

### INDUSTRIAL APPLICABILITY

According to the invention, the low-temperature adhesion of a halogen-free pressure-sensitive adhesive tape can be heightened to thereby improve suitability for binding.

1. A halogen-free pressure-sensitive adhesive tape which comprises a tape substrate made of a non-halogen resin composition containing no halogen elements and, applied to at least one side of the substrate, a pressure-sensitive adhesive which comprises natural rubber, an acrylic resin, a tackifier resin, an antioxidant, and a plasticizer having a molecular weight of 450-3,000 and a solidifying point of from −30° C. to −55° C.

2. The halogen-free pressure-sensitive adhesive tape according to claim 1, wherein the plasticizer is a polyester plasticizer or a trimellitic acid compound plasticizer.

3. The halogen-free pressure-sensitive adhesive tape according to claim 1 or 2, wherein the content of the plasticizer is 8-12 parts by weight per 100 parts by weight of the sum of the natural rubber, the acrylic resin, the tackifier resin, and the antioxidant.

4. The halogen-free pressure-sensitive adhesive tape according to any one of claims 1 to 3, which is for use in wire harness binding.
